(19) United States
(12) Patent Application Publication
(10) Pub. No.: US 2018/0068810 A1
(43) Pub. Date: Mar. 8, 2018

(54) SPRING PLATE, PUSH SWITCH INCLUDING SPRING PLATE, AND ELECTRONIC DEVICE INCLUDING PUSH SWITCH

(71) Applicants: CITIZEN ELECTRONICS CO., LTD., Yamanashi-ken (JP); CITIZEN WATCH CO., LTD., Tokyo (JP)

(72) Inventor: Ryo WAKUDA, Kofu-shi (JP)

(21) Appl. No.: 15/642,615

(22) Filed: Jul. 6, 2017

Related U.S. Application Data
(60) Provisional application No. 62/382,866, filed on Sep. 2, 2016.

(51) Int. Cl. H01H 13/50; H01H 13/10; H01H 13/14

(52) U.S. Cl. CPC H01H 13/50; H01H 13/14; H01H 13/10

(57) ABSTRACT

In a first aspect of the present disclosure, a spring plate includes a central portion; a first leg portion projecting outward from an edge of the central portion; and a second leg portion projecting outward from the edge of the central portion. The first leg portion includes a hollow portion that is positioned within an outline of the first leg portion in a top plan view, and the second leg portion includes a hollow portion that is positioned within an outline of the second leg portion in a top plan view.

### CROSS-REFERENCE TO RELATED APPLICATION

This application is a new U.S. patent application that claims benefit of U.S. provisional application No. 62/382,866 filed on Sep. 2, 2016, the disclosures of which are incorporated herein by reference in its entirety.

### BACKGROUND OF THE INVENTION

### Field of the Invention

The subject matter herein generally relates to a spring plate, a push switch including the spring plate, and relates to an electronic device including the push switch.

Various electronic devices include push switches. Various electronic devices may be computers, portable communication devices, wearable devices, and game consoles, on-vehicle devices for example.

### Description of the Related Art

It is open to the public that a conventional spring plate including at least two arc shaped protrusion each protruding toward a circular circuit that is positioned under the center of the spring plate (For reference, see Japanese Utility Model Publication No. 3112330).

Also, it is open to the public that a conventional spring plate including a movable contact part that is connected to a connecting portion with a slit on either side of the movable contact part and also including a protruding portion that can be a contact portion (For reference, see Japanese Unexamined Patent Application Publication No. 2005-340126).

Furthermore, it is open to the public that a conventional spring plate includes a dome shape bulging in a first direction and a protrusion protruding in a second direction that is opposite to the first direction (For reference, see Japanese Utility Model Publication No. H7-25533).

### SUMMARY OF THE INVENTION

In a first aspect of the present inventive subject matter, a spring plate includes a central portion; a first leg portion projecting outward from an edge of the central portion; and a second leg portion projecting outward from the edge of the central portion. The first leg portion includes a hollow portion that is positioned within an outline of the first leg portion in a top plan view, and the second leg portion includes a hollow portion that is positioned within an outline of the second leg portion in a top plan view.

In a second aspect of the present inventive subject matter, a spring plate includes a central portion; a first leg portion projecting outward from an edge of the central portion; a second leg portion projecting outward from the edge of the central portion; a third leg portion projecting outward from the edge of the central portion; and a fourth leg portion projecting outward from the edge of the central portion. The first leg portion, the second leg portion, the third leg portion and the fourth leg portion are positioned around the central portion at regular intervals. The first leg portion includes a hollow portion that is positioned within an outline of the first leg portion in a top plan view. The second leg portion includes a hollow portion that is positioned within an outline of the second leg portion in a top plan view. The third leg portion includes a hollow portion that is positioned within an outline of the third leg portion in a top plan view. The fourth leg portion includes a hollow portion that is positioned within an outline of the fourth leg portion in a top plan view.

In a third aspect of the present inventive subject matter, a push switch includes a spring plate including a central portion, a leg portion projecting outward from an edge of the central portion. The leg portion includes a hollow portion that is positioned within an outline of the leg portion in a top plan view. The push switch further includes a first electrode arranged below the central portion of the spring plate; and a second electrode on that the hollow portion of the leg portion of the spring plate is arranged.

In a fourth aspect of the present inventive subject matter, a push switch includes a spring plate including a central portion, a leg portion projecting outward from an edge of the central portion. The leg portion includes a hollow portion that is positioned within an outline of the leg portion in a top plan view. The push switch further includes a substrate including a first surface, a second surface that is positioned opposite to the first surface, a peripheral side surface between the first surface and the second surface; and a first electrode arranged on the first surface of the substrate and a second electrode arranged on the first surface of the substrate. The hollow portion of the leg portion of the spring plate includes a bottom including a first surface and a second surface opposite to the first surface of the bottom. The hollow portion further includes a surrounding surface that surrounds the first surface of the bottom of the hollow portion, and the second surface of the bottom of the hollow portion being arranged on the second electrode arranged on the first surface of the substrate.

### BRIEF DESCRIPTION OF THE DRAWING

### Brief Description of the Drawing

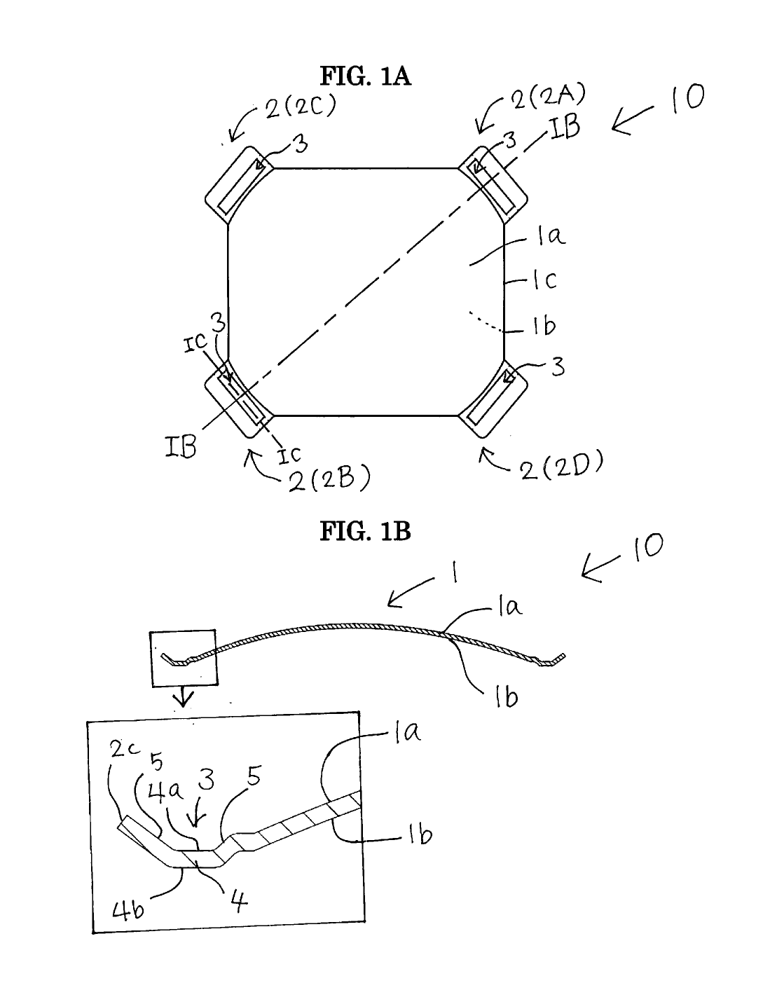

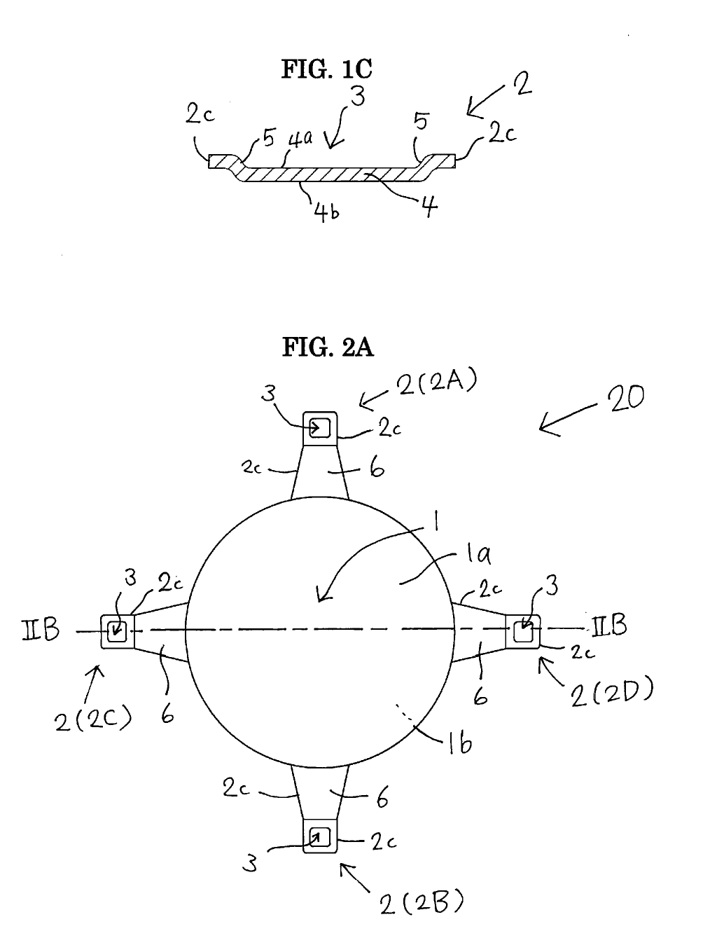

FIG. 1A shows a top plan view of a spring plate according to a first embodiment of the subject matter.

FIG. 1B shows a cross-sectional view of a spring plate, taken along a dot-and-dash line IB-IB that is a first direction shown in FIG. 1A. FIG. 1B also shows an enlarged view of a cross-sectional view of a leg portion in the first direction.

FIG. 1C shows a cross-sectional view of a spring plate, taken along a dot-and-dash line IC-IC in a second direction shown in FIG. 1A. FIG. 1C especially shows a cross-sectional enlarged view of a leg portion in the second direction that is perpendicular to the first direction.

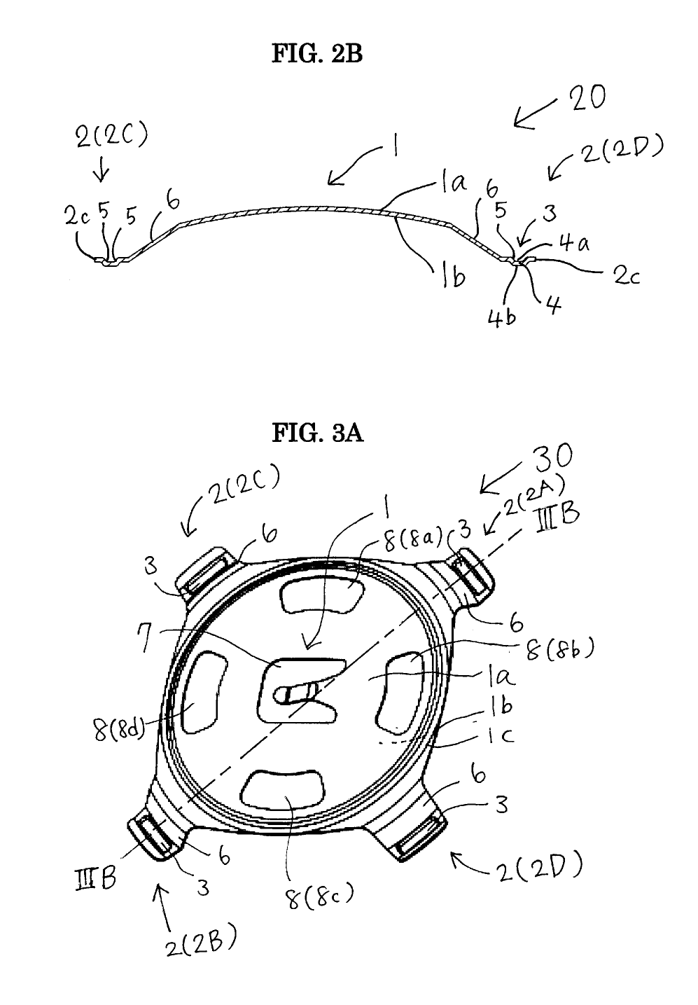

FIG. 2A shows a top plan view of a spring plate according to a second embodiment of the subject matter.

FIG. 2B shows a cross-sectional view of a spring plate, taken along a dot-and-dash line IIB-IIB shown in FIG. 2A.

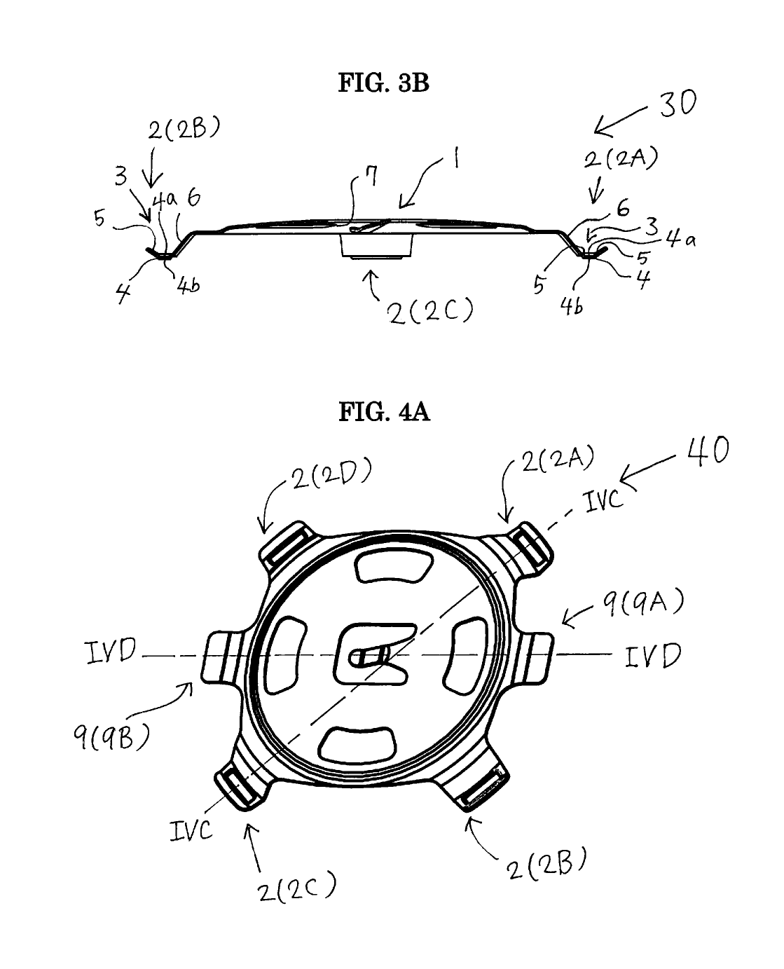

FIG. 3A shows a top perspective view of a spring plate according to a third embodiment of the subject matter.

FIG. 3B shows a cross-sectional view of a spring plate, taken along a dot-and-dash line IIIB-IIIB shown in FIG. 3A.

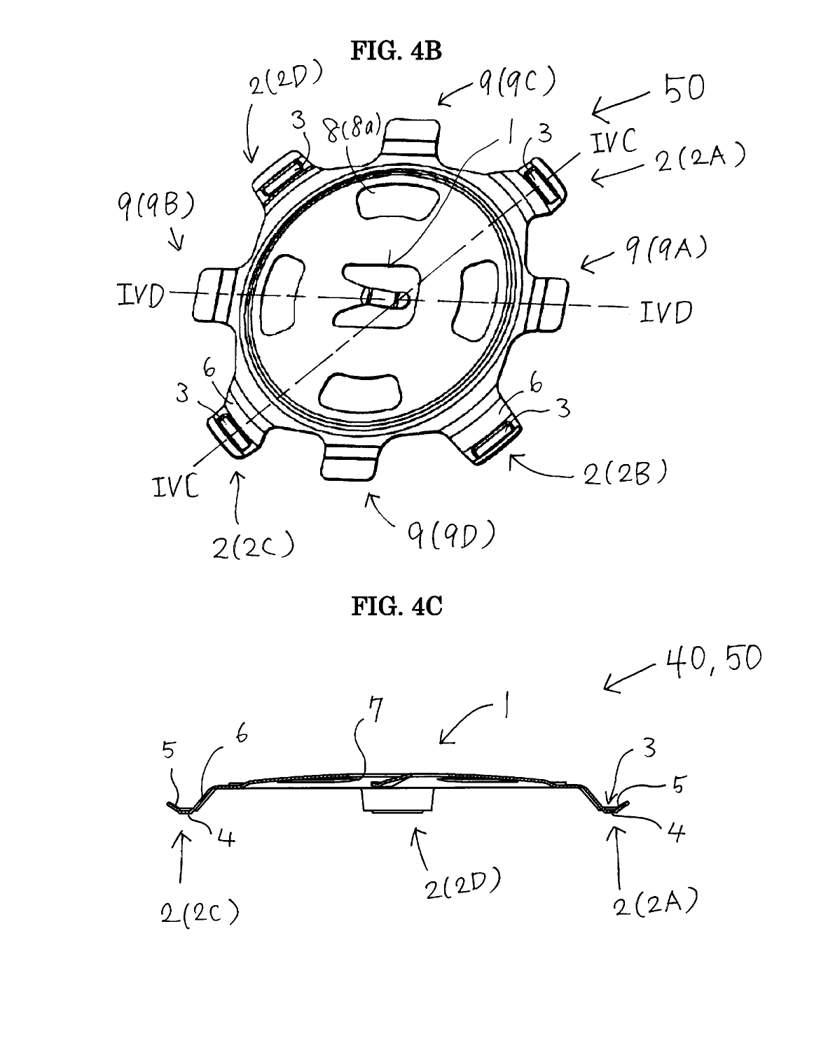

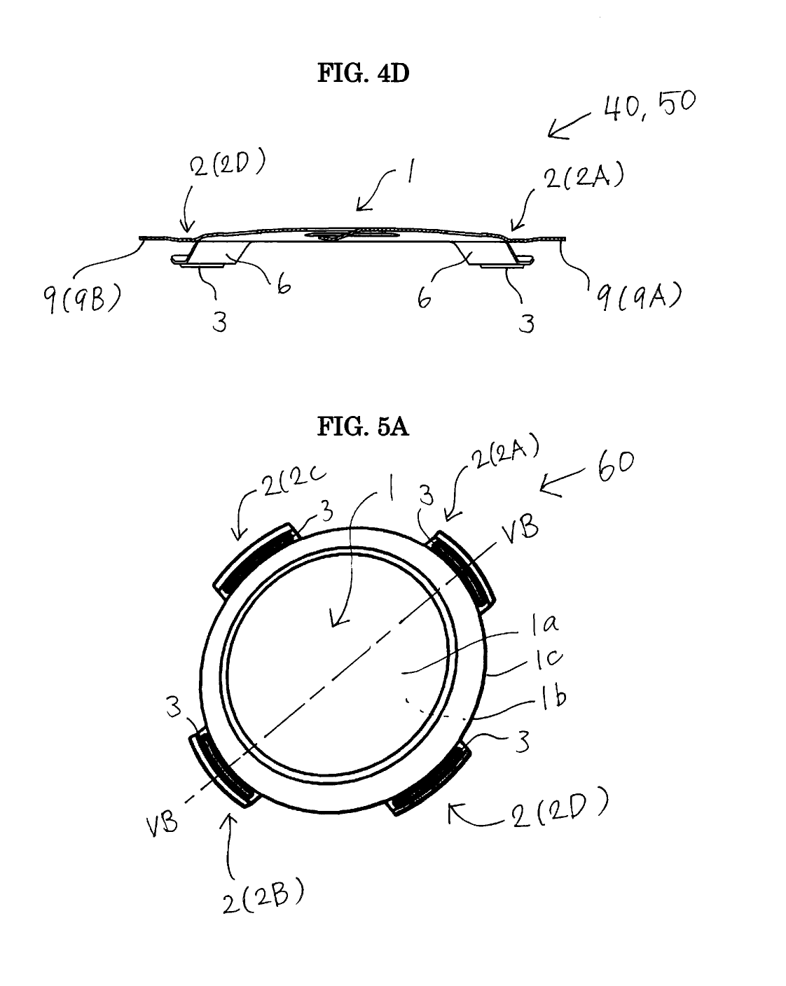

FIG. 4A shows a top perspective view of a spring plate according to a fourth embodiment of the subject matter. The spring plate includes two support leg portions.

FIG. 4B shows a top perspective view of a spring plate according to a fifth embodiment of the subject matter. The spring plate includes four support leg portions.

FIG. 4C shows a cross-sectional view of a spring plate, taken along a dot-and-dash line IVC-IVC shown in FIG. 4A or FIG. 4B.

FIG. 4D also shows a cross-sectional view of a spring plate, taken along a dot-and-dash line IVD-IVD shown in FIG. 4A or FIG. 4B.

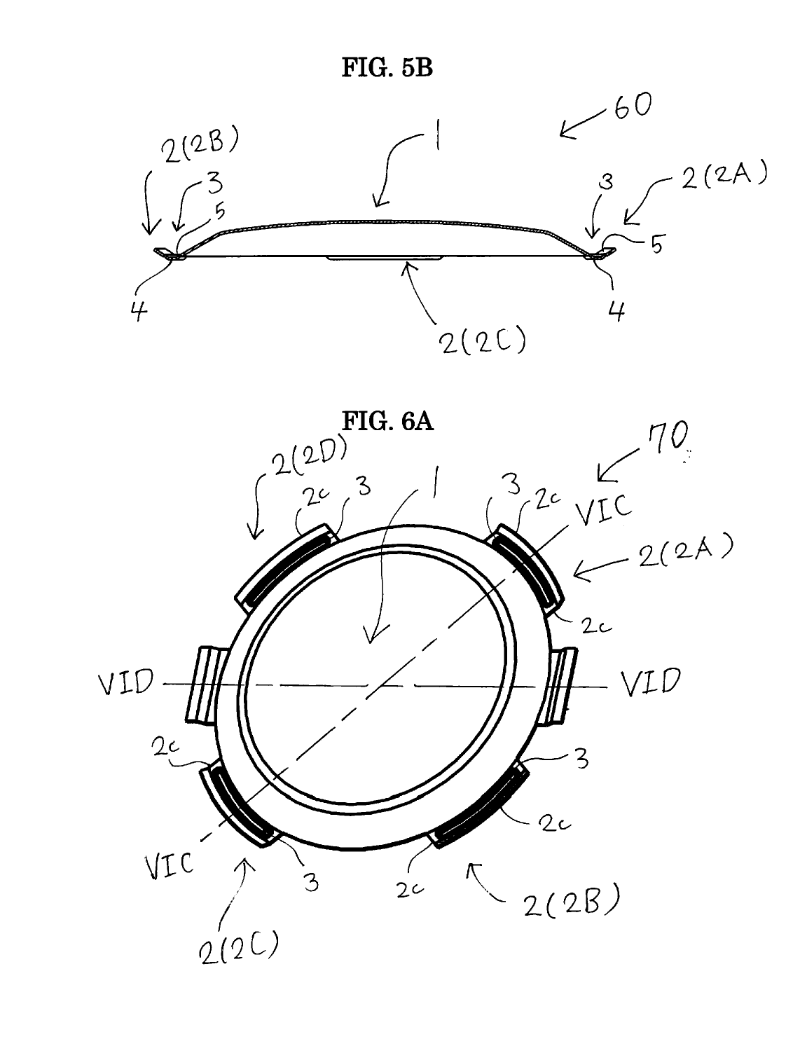

FIG. 5A shows a top perspective view of a spring plate according to a sixth embodiment of the subject matter.

FIG. 5B shows a cross-sectional view of a spring plate, taken along a dot-and-dash line VB-VB shown in FIG. 5A.

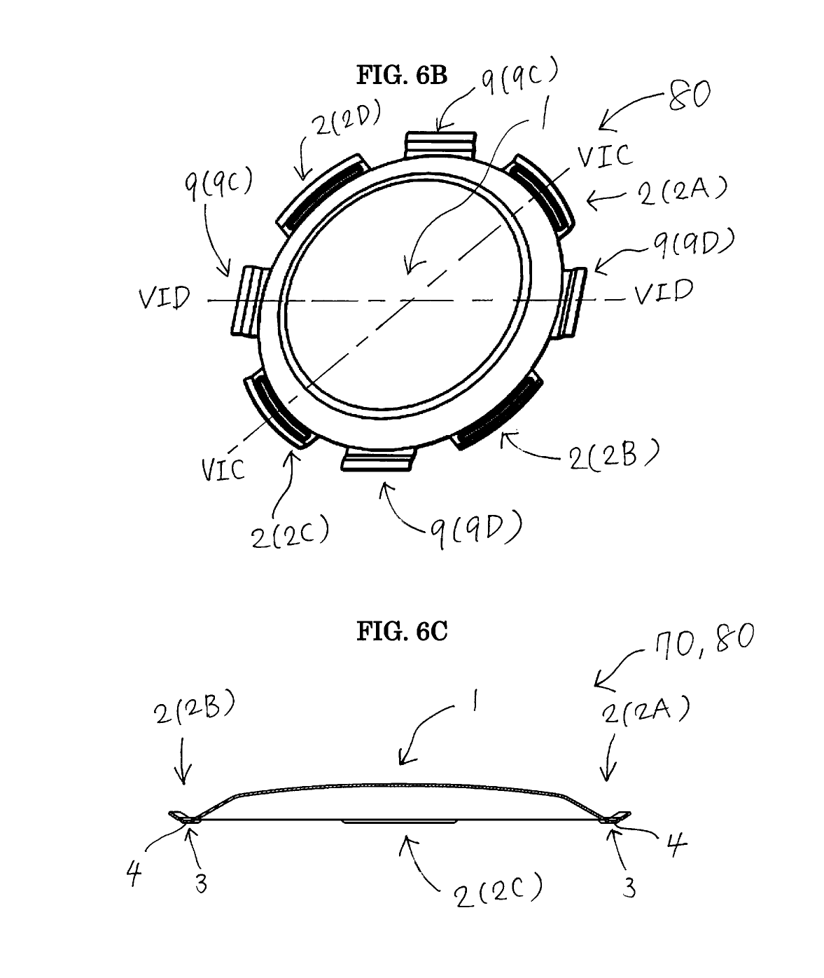

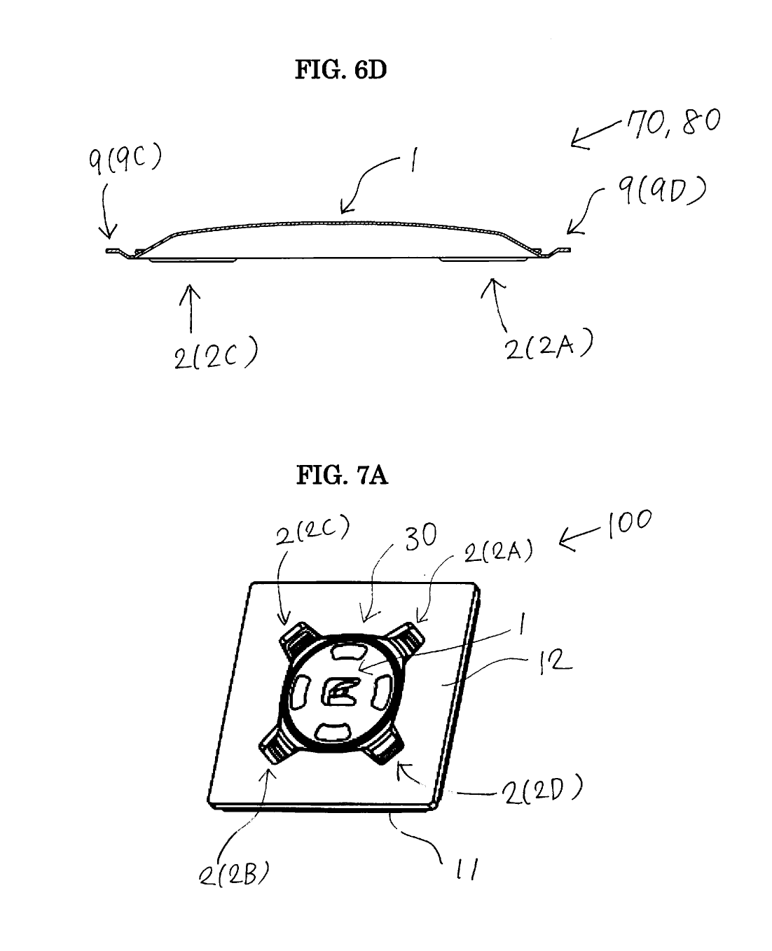

FIG. 6A shows a top perspective view of a spring plate according to a seventh embodiment of the subject matter.

FIG. 6B shows a top perspective view of a spring plate according to an eighth embodiment of the subject matter.

FIG. 6C shows a cross-sectional view of a spring plate, taken along a dot-and-dash line VIC-VIC shown in FIG. 6A or FIG. 6B.

FIG. 6D shows a cross-sectional view of a spring plate, taken along a dot-and-dash line VID-VID shown in FIG. 6A or FIG. 6B. FIG. 6D shows a cross-sectional view crossing across a support leg portion.

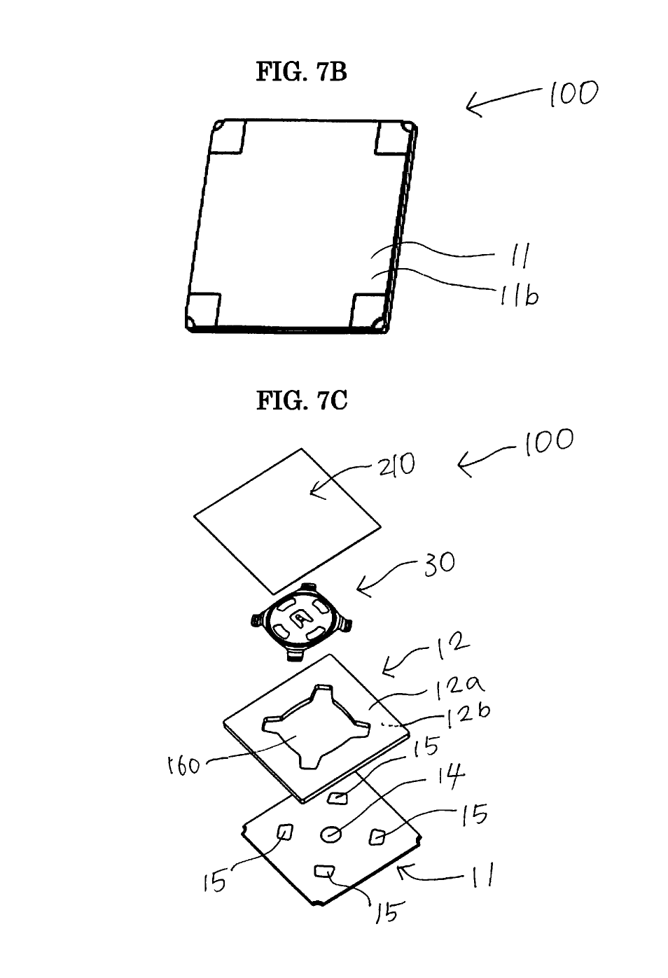

FIG. 7A shows a top perspective view of a push switch according to a ninth embodiment of the subject matter.

FIG. 7B shows a bottom perspective view of a push switch shown in FIG. 7A.

FIG. 7C shows an explosive perspective view of a push switch shown in FIG. 7A. The push switch may further include a sheet covering the spring plate.

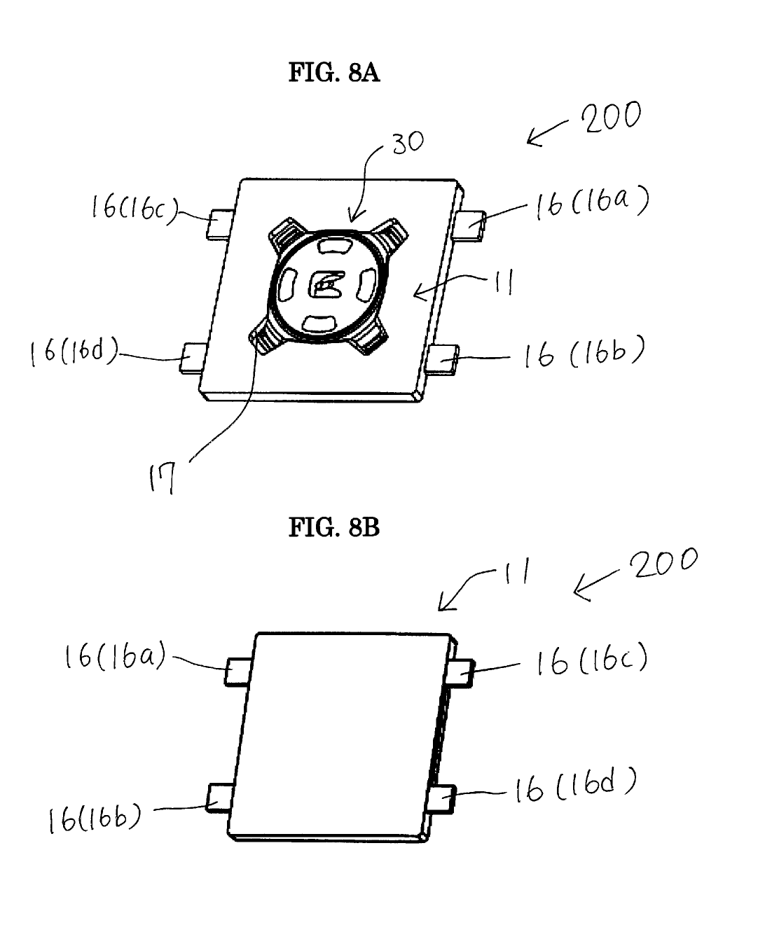

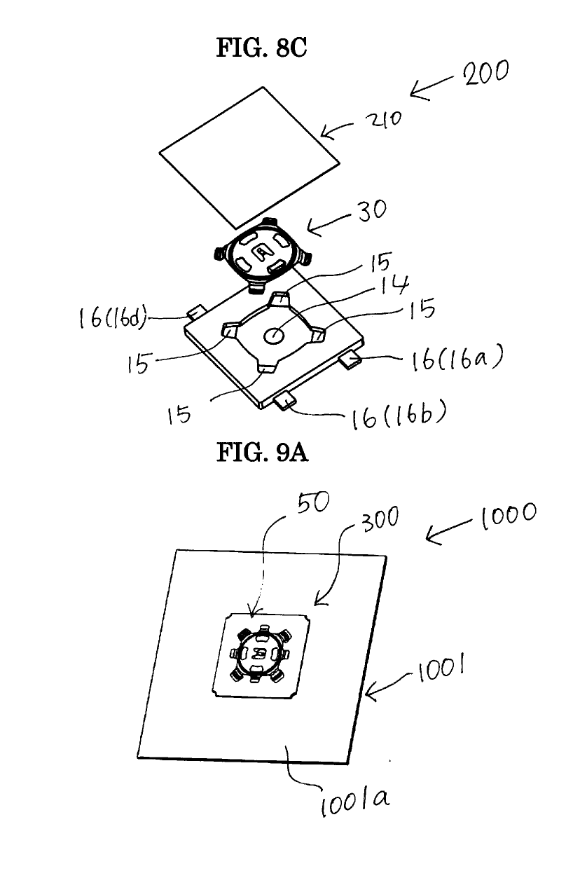

FIG. 8A shows a top perspective view of a push switch according to a tenth embodiment of the subject matter.

FIG. 8B shows a bottom perspective view of a push switch shown in FIG. 8A.

FIG. 8C shows an explosive perspective view of a push switch shown in FIG. 8A. The push switch further includes a sheet covering the spring plate.

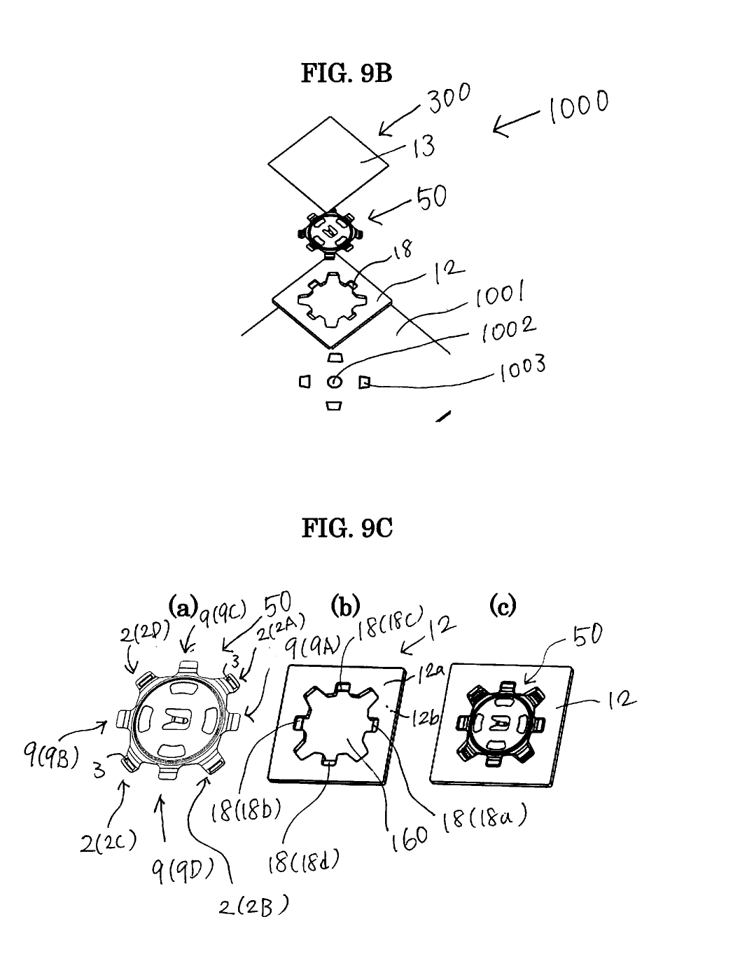

FIG. 9A shows a top perspective view of a push switch according to an eleventh embodiment of the subject matter. In this embodiment the push switch is electrically mounted on a surface of a motherboard, which may belong to an electronic device.

FIG. 9B shows an explosive perspective view of a push switch shown in FIG. 9A.

FIG. 9C (a) shows a spring plate. FIG. 9C (b) shows a frame 12. FIG. 9C (c) shows the frame in which the spring plate is set.

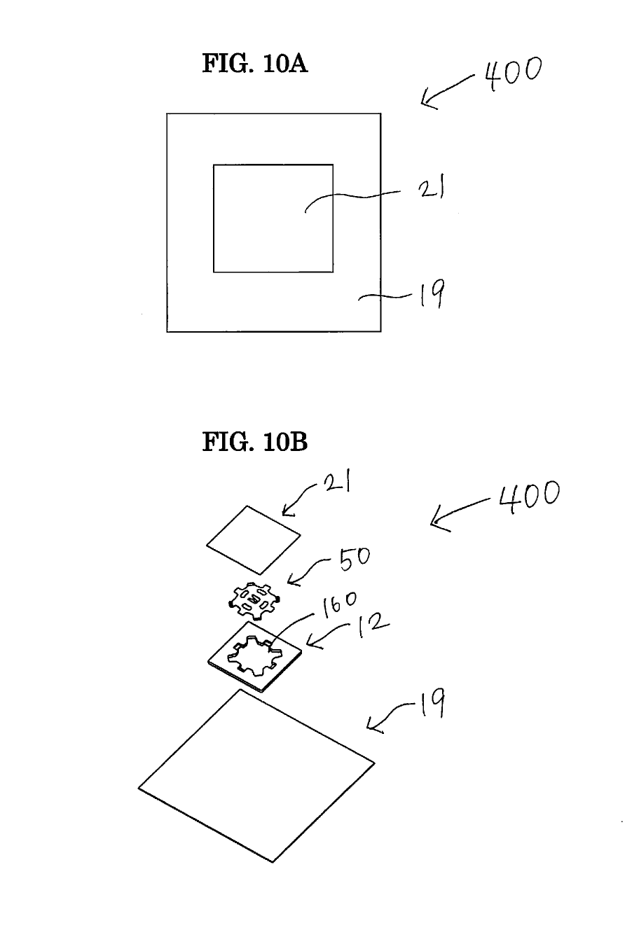

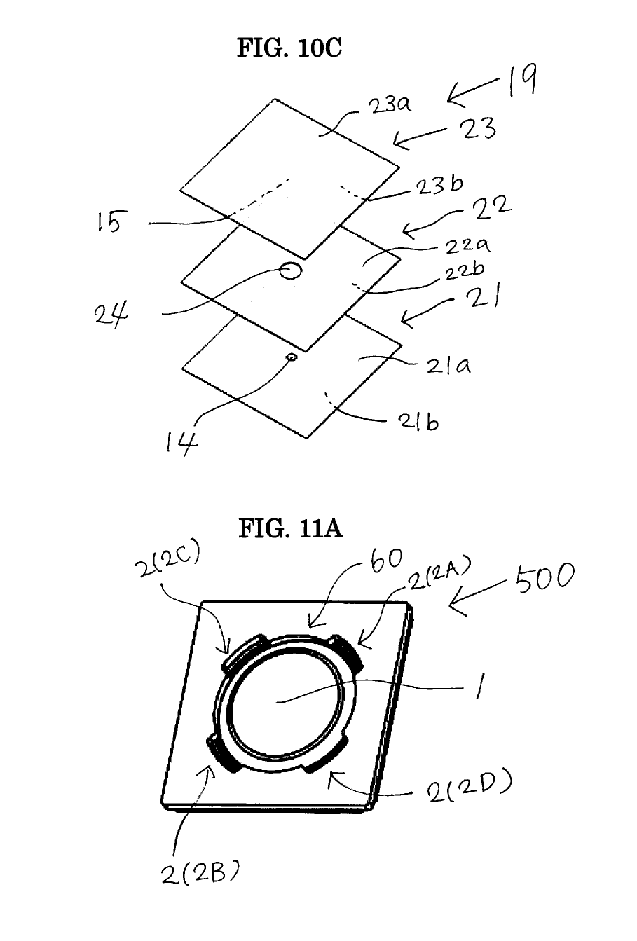

FIG. 10A shows a top plan view of a push switch according to a twelfth embodiment of the subject matter.

FIG. 10B shows an explosive perspective view of a push switch shown in FIG. 10A.

FIG. 10C shows a film including a first layer with an upper electrode, a second layer with a hole, and a third layer with a lower electrode.

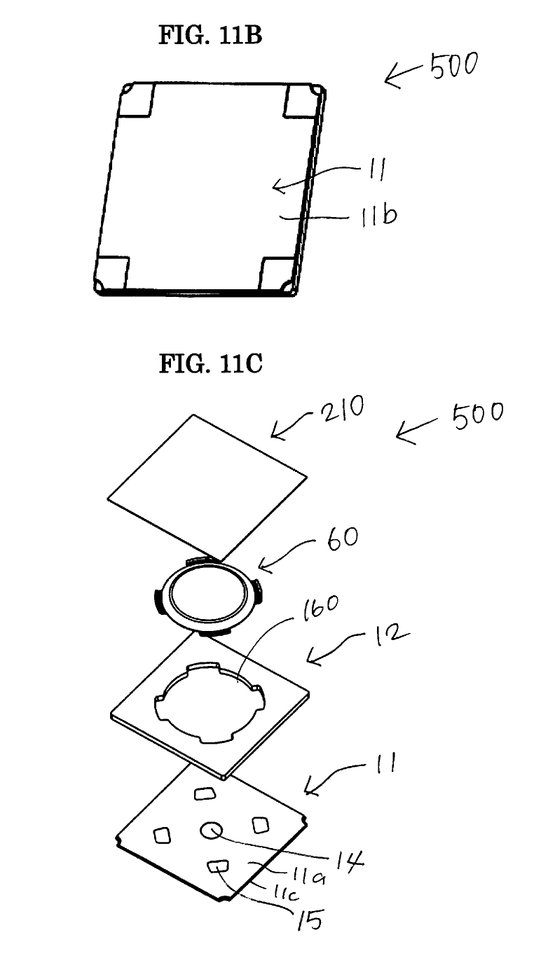

FIG. 11A shows a top perspective view of a push switch according to a thirteenth embodiment of the subject matter.

FIG. 11B shows a bottom perspective view of a push switch shown in FIG. 11A.

FIG. 11C shows an explosive perspective view of a push switch shown in FIG. 11A. The push switch further includes a sheet covering the spring plate.

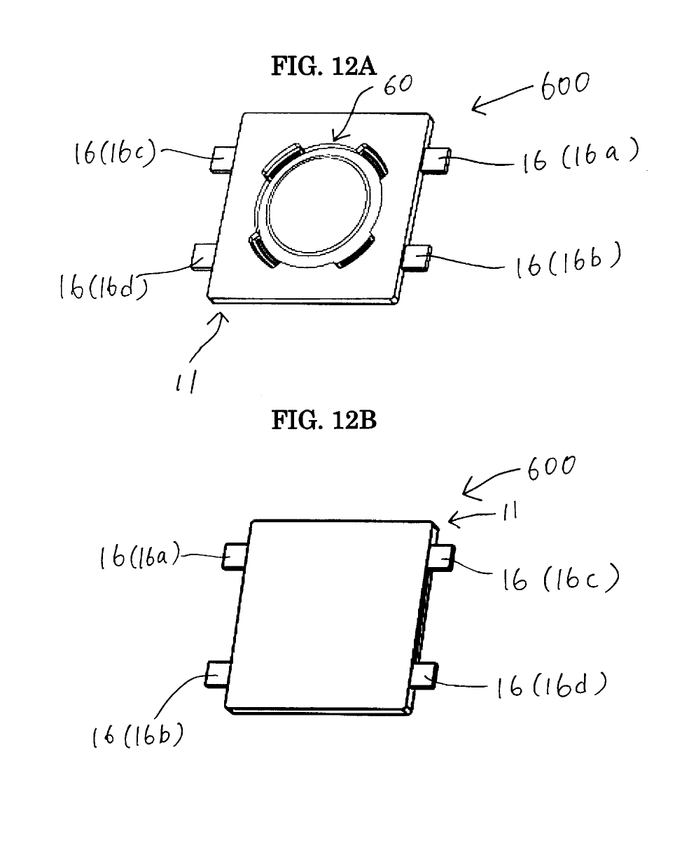

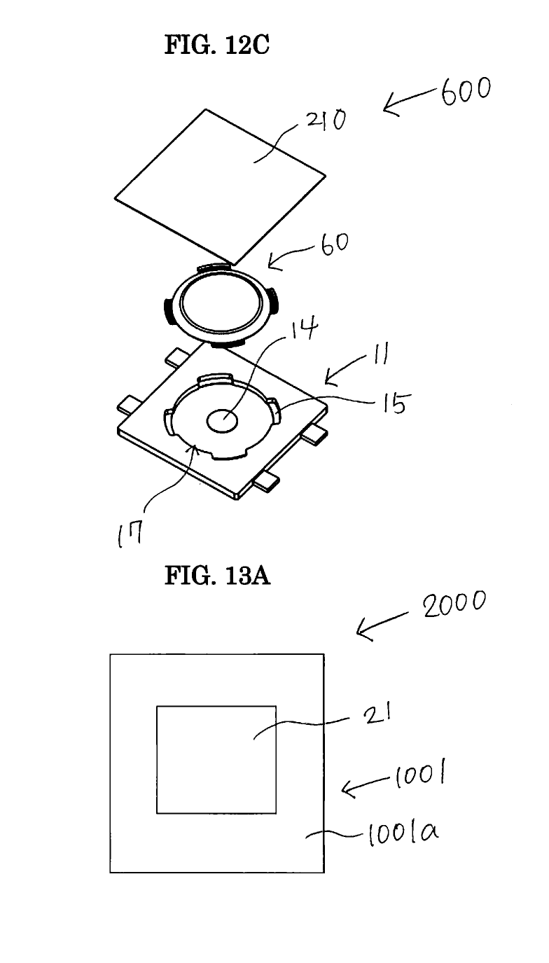

FIG. 12A shows a top perspective view of a push switch according to a fourteenth embodiment of the subject matter.

FIG. 12B shows a bottom perspective view of a push switch shown in FIG. 12A.

FIG. 12C shows an explosive perspective view of a push switch.

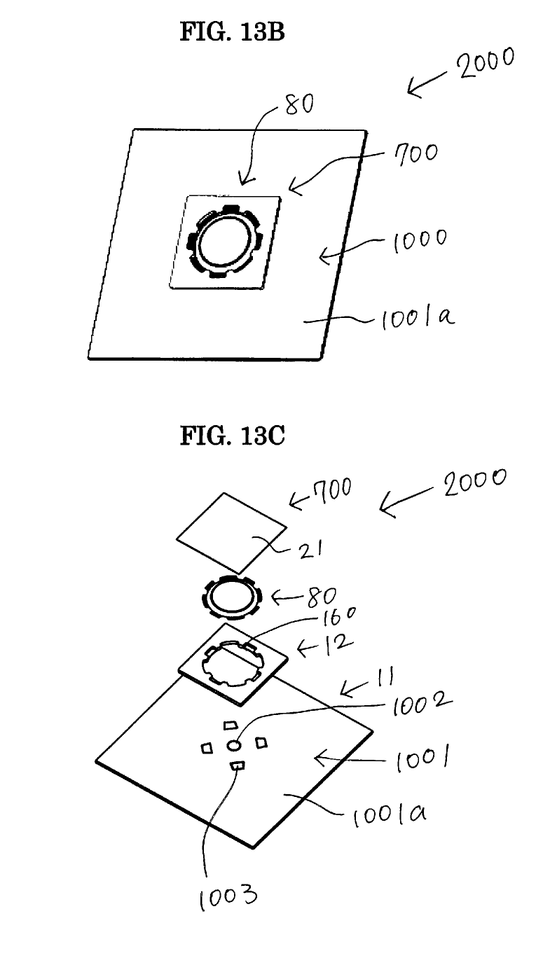

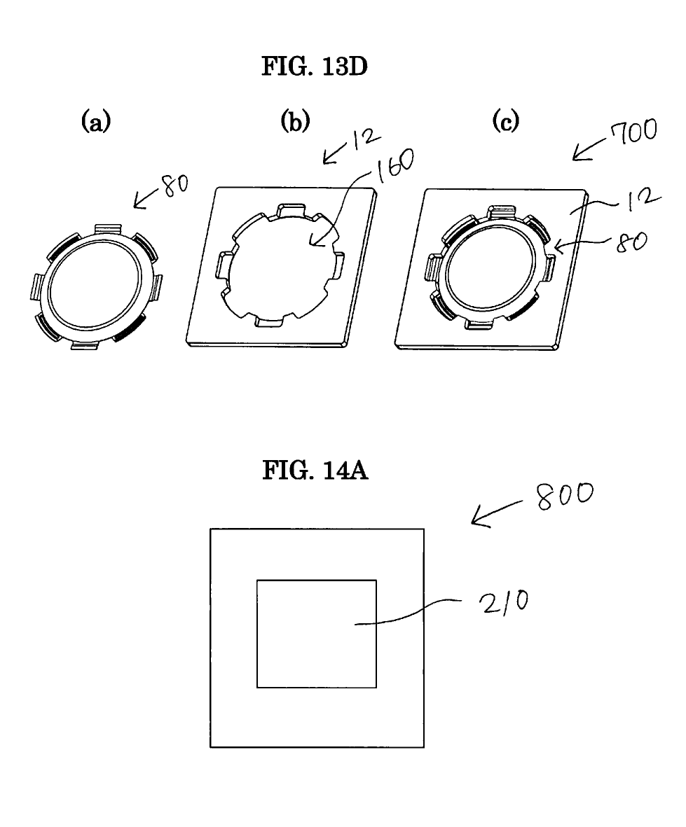

FIG. 13A shows a top perspective view of a push switch according to a fifteenth embodiment of the subject matter.

FIG. 13B shows a push switch with a sheet, which covers a spring plate shown in FIG. 13A, removed from the push switch.

FIG. 13C shows an explosive perspective view of a push switch shown in FIG. 13A.

FIG. 13D (a) shows a spring plate. FIG. 13D (b) shows a frame 12 with an opening. FIG. 13 (c) shows the frame with the opening in which the spring plate 60 is set.

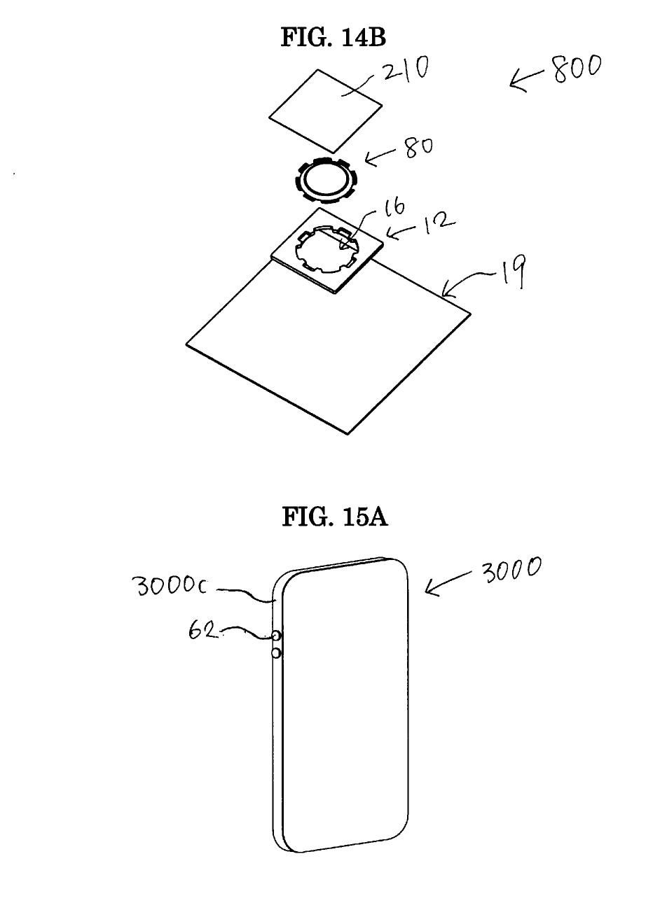

FIG. 14A shows a top perspective view of a push switch according to a sixteenth embodiment of the subject matter.

FIG. 14B shows an explosive perspective view of a push switch shown in FIG. 14A.

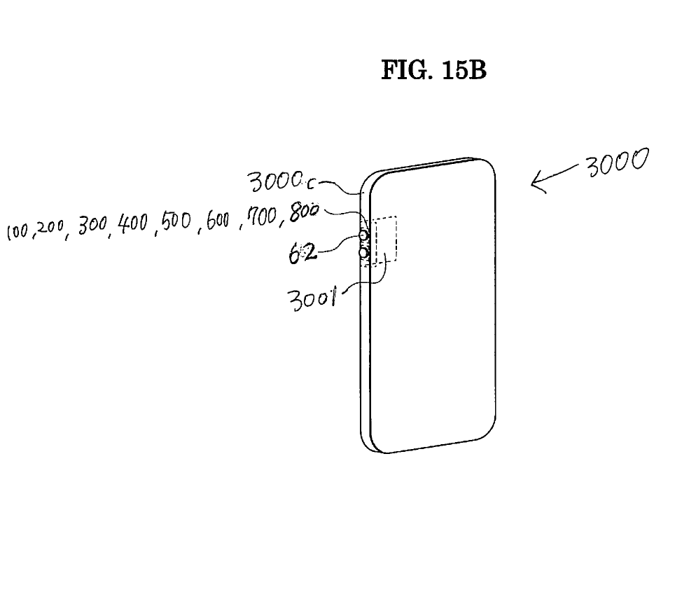

FIG. 15A shows an electronic device including a switch according to an embodiment of the subject matter.

FIG. 15B shows a push switch according to an embodiment of the subject matter. The push switch may be mounted on a motherboard that is a flexible printed circuit board.

### DETAILED DESCRIPTION OF EMBODIMENTS

As used herein, the term “and/or” includes any and all combinations of one or more of the associated listed items.

The terminology used herein is for the purpose of describing particular embodiments only and is not intended to be limiting of the subject matter. As used herein, the singular forms “a”, “an” and “the” are intended to include the plural forms as well, unless the context clearly indicates otherwise.

As illustrated in the figures submitted herewith, some sizes of structures or portions may be exaggerated relative to other structures or portions for illustrative purposes.

Relative terms such as “below” or “above” or “upper” or “lower” or “top” or “bottom” may be used herein to describe a relationship of one element, layer or region to another element, layer or region as illustrated in the figures. It will be understood that these terms are intended to encompass different orientations of a device in addition to the orientation depicted in the figures.

In a first aspect of the subject matter, a spring plate includes a central portion, and a leg portion projecting outward from an edge of the central portion. The leg portion of the spring plate includes a hollow portion that is positioned within an outline of the leg portion in a top plan view.

In a second aspect of the subject matter, a spring plate includes a central portion, a first leg portion projecting outward from an edge of the central portion, and a second leg portion projecting outward from the edge of the central portion. The first leg portion includes a hollow portion that is positioned within an outline of the first leg portion in a top plan view. The second leg portion includes a hollow portion that is positioned within an outline of the second leg portion in a top plan view.

Also, it is suggested that the spring plate may further include a first support leg portion projecting outward from the edge of the central portion and being positioned between the first leg portion and the second leg portion, and a second support leg portion projecting outward from the edge of the central portion and being positioned opposite to the first support leg portion.

Embodiments of the subject matter now will be described more hereinafter with reference to the accompanying drawings, in which embodiments of the subject matter are shown. This subject matter may, however, be embodied in many different forms and should not be construed as limited to the embodiments set forth herein. Rather, these embodiments are provided so that this disclosure will be thorough and complete, and will fully convey the scope of the subject matter to those skilled in the art.

FIG. 1A shows a top plan view of a spring plate according to a first embodiment of the subject matter.

FIG. 1B shows a cross-sectional view of a spring plate, taken along a dot-and-dash line IB-IB that is a first direction shown in FIG. 1A. FIG. 1B also shows an enlarged view of a cross-sectional view of a leg portion in the first direction.

FIG. 1C shows a cross-sectional view of a spring plate, taken along a dot-and-dash line IC-IC in a second direction shown in FIG. 1A. FIG. 1C especially shows a cross-sectional enlarged view of a leg portion in the second direction that is perpendicular to the first direction.

A spring plate 10 includes a central portion 1, and a leg portion 2 projecting outward from an edge 1c of the central portion 1. The leg portion 2 of the spring plate 10 includes a hollow portion 3 that is positioned within an outline 1c of the leg portion 2 in a top plan view.

With this configuration, a lower surface 4b of the hollow portion 3 of the spring plate 10 is positioned at a lowest position in the spring plate 10.

The hollow portion 3 of the leg portion 2 includes a bottom 4 and a surrounding surface 5 that surrounds the bottom 4. The lower surface 4b of the hollow portion 3 is the lower surface 4b of the bottom 4 of the hollow portion 3. The central portion 1 of the spring plate 10 includes a convex shape.

When the spring plate 10 is used in a push switch, the convex shape 1 of the spring plate 10 may be arranged over a first electrode and the lower surface 46 of the bottom 4 of the hollow portion 3 of the leg portion 2 of the spring plate 10 may be arranged on a second electrode.

When the push switch is pressed down, the convex shape 1 of the central portion 1 of the spring plate 10 will be pressed out of the convex shape or crushed on the first electrode, and the lower surface 4b of the hollow portion 3 will slide out on the second electrode. The spring plate 1 may be made of metal.

Accordingly, the first electrode and the second electrode are electrically connected by the spring plate 1, and the push switch acts as a switch.

The spring plate 1 may be made of stainless, for example. The spring plate 1 may be made of alloy steel, nickel alloy, aluminum alloy, and/or titanium, for example.

The shape of the hollow portion 3 at the leg portion 2 of the spring plate 1 according to an embodiment of the subject matter may less impair a surface quality of the second electrode, compared to a shape including and/or connected to a part of a cross section of a spring plate, for example.

The spring plate may be cut out from a metal plate. The outline of the spring plate including the leg portion may be a cross section of the spring plate that is made of metal. The cross section of the spring plate tends to impair a surface quality of an electrode on which the spring plate is arranged. Since the hollow portion at the leg portion of the spring plate is positioned within the outline of the spring plate, the lower surface 4b of the bottom 4 of the hollow portion on the second electrode is free from a cross section of the spring plate.

The hollow portion of the leg portion of the spring plate 10 may include a cup shape.

For more details, a spring plate 10 includes a central portion 1, a first leg portion 2 (2A) projecting outward from an edge 1c of the central portion 1. The spring plate 10 further includes a second leg portion projecting outward from the edge 1c of the central portion 1. The first leg portion 2 (2A) includes a hollow portion 3 that is positioned within an outline of the first leg portion 2 (2A) in a top plan view. The second leg portion 2 (2B) includes a hollow portion 3 that is positioned within an outline of the second leg portion 2 (2B).

The first leg portion 2 (2A) may be positioned with a space from the second leg portion 2 (2B). The first leg portion 2 (2A) may be positioned opposite to the second leg portion 2 (2B).

The spring plate 10 may further include a third leg portion 2 (2C) projecting outward from the edge 1c of the central portion 1. The spring plate 10 may further include a fourth leg portion 2 (2D) projecting outward from the edge 1c of the central portion 1. The third leg portion 2 (2C) includes a hollow portion that is positioned within an outline of the third leg portion in a top plan view. The fourth leg portion 2 (2D) includes a hollow portion that is positioned within an outline of the fourth leg portion 2 (2D) in a top plan view.

FIG. 2A shows a top plan view of a spring plate 20 according to a second embodiment of the subject matter. FIG. 2B shows a cross-sectional view of a spring plate, taken along a dot-and-dash line IIB-IIB shown in FIG. 2A.

FIG. 2B shows a spring plate 20 includes four leg portions that are a first leg portion 2 (2A), a second leg portion 2 (2B), a third leg portion 2 (2C) and a fourth leg portion 2 (2D). In this embodiment, a hollow portion 3 in each leg portion 2 is positioned away with a distance from the edge 1c of the central portion 1. The distance from the edge 1c of the central portion 1 to the hollow portion may be longer than a width of the hollow portion 3 in each leg portion 2. If the distance from the edge 1c of the central portion 1 to the hollow portion 3 of the leg portion 2 is longer, it is possible to make a switch stroke to an electrode below the central portion 1 of the spring plate 1 longer.

In another embodiment, it is possible to provide a spring plate with three leg portions. A spring plate includes a central portion 1, a first leg portion 2 (2A) projecting outward from an edge 1c of the central portion 1, a second leg portion 2 (2B) projecting outward from the edge 1c of the central portion 1, a third leg portion 2 (2C) projecting outward from the edge 1c of the central portion 1. The first leg portion 2 (2A), the second leg portion 2 (2B) and the third leg portion 2 (2C) may be positioned around the central portion at regular intervals.

The first leg portion 2 (2A) and the second leg portion 2 (2B) may be positioned at an angle of 120 degrees to each other. The second leg portion 2 (2B) and the third leg portion 2 (2C) may be positioned at an angle of 120 degrees to each other. The third leg portion 2 (2C) and the first leg portion 2 (2A) may be positioned at an angle of 120 degrees to each other.

The first leg portion 2 (2A) includes a hollow portion 3 that is positioned within an outline 2c of the first leg portion 2 (2A) in a top plan view. The second leg portion 2 (2B) includes a hollow portion 3 that is positioned within an outline 2c of the second leg portion 2 (2B) in a top plan view. The third leg portion 2 (2C) includes a hollow portion 3 that is positioned within an outline 2c of the third leg portion 2 (2C) in a top plan view.

FIG. 3A shows a top perspective view of a spring plate according to a third embodiment of the subject matter. FIG. 3B shows a cross-sectional view of a spring plate, taken along a dot-and-dash line IIIB-IIIB shown in FIG. 3A. FIG. 1B also shows an enlarged view of a leg portion in a first direction.

A spring plate 30 includes a central portion 1, a first leg portion 2 (2A) projecting outward from an edge 1c of the central portion 1, a second leg portion 2 (2A) projecting outward from the edge 1c of the central portion 1, a third leg portion 2 (2C) projecting outward from the edge 1c of the central portion, and a fourth leg portion 2 (2D) projecting outward from the edge 1c of the central portion 1. The first leg portion 2 (2A), the second leg portion 2 (2B), the third leg portion 2 (2C) and the fourth leg portion 2 (2D) are positioned around the central portion 1 at regular intervals. The first leg portion 2 (2A) includes a slant portion 6 that is positioned closer to the central portion 1 than the hollow portion 3 of the first leg portion 2 (2A). The second leg portion 2 (2B) includes a slant portion 6 that is positioned closer to the central portion 1 than the hollow portion 3 of the second leg portion 2 (2B). The third leg portion 2 (2C) includes a slant portion 6 that is positioned closer to the edge 1c of the central portion 1 that is positioned closer to the edge 1c of the central portion 1 than the hollow portion 3 the third leg portion 2 (2C). The fourth leg portion 2 (2C) includes a slant portion 6 that is positioned closer to the edge 1c of the central portion 1 than the hollow portion 3 of the fourth leg portion 2 (2C). If the distance from the edge 1c of the central portion 1 to the hollow portion 3 of the leg portion 2 is longer, it is possible to make a switch stroke to an electrode below the central portion 1 of the spring plate 1 longer. Accordingly, the leg portion 2 of the spring plate may include one or more slant portions and/or level surfaces. This structure may give a user a better click feeling when the push switch is pressed.

The first leg portion 2 (2A) includes a hollow portion 3 that is positioned within an outline 2c of the first leg portion 2 (2A) in a top plan view. The second leg portion 2 (2B) includes a hollow portion 3 that is positioned within an outline 2c of the second leg portion 2 (2B) in a top plan view. The third leg portion 2 (2C) includes a hollow portion 3 that is positioned within an outline 2c of the third leg portion 2 (2C) in a top plan view. The fourth leg portion 2 (2D) includes a hollow portion 3 that is positioned within an outline 2c of the fourth leg portion 2 (2D) in a top plan view.

FIG. 4A shows a top perspective view of a spring plate 40 according to a fourth embodiment of the subject matter. The spring plate 40 includes two support leg portions.

FIG. 4B shows a top perspective view of a spring plate 50 according to a fifth embodiment of the subject matter. The spring plate 50 includes four support leg portions.

As shown in FIG. 4A, the spring plate 40 includes a first support leg portion 9 (9A) projecting outward from the edge 1c of the central portion 1. The spring plate 30 further includes a second support leg portion 9 (9B) projecting outward from the edge 1c of the central portion 1. The first support leg portion 9 (9A) may be positioned opposite to the second support leg portion 9 (9B). The spring plate 50 further includes a third support leg portion 9 (9C) projecting outward from the edge 1c of the central portion 1 and a fourth support leg portion 9 (9D) projecting outward from the edge 1c of the central portion 1. The third support leg portion 9 (9C) is positioned opposite to the fourth support leg portion 9 (9D). FIG. 4C shows a cross-sectional view of a spring plate 40, taken along a dot-and-dash line IVC-IVC shown in FIG. 4A. FIG. 4D also shows a cross-sectional view of a spring plate 40, taken along a dot-and-dash line IVC-IVC shown in FIG. 4A or FIG. 4B. As shown in FIG. 4D, the first support leg portion 9 (9A) is positioned higher than the hollow portion 3 of the first leg portion 2 (2A) when a convex shape of the central portion 1 of the spring plate 40 is arranged upward.

The second support leg portion 9 (9B) is positioned higher than the hollow portion 3 of the fourth leg portion 2 (2D). Since the support leg portions 9 of the spring plate 40 are positioned higher than the hollow portions 3 of the leg portions 2 of the spring plate 40, the spring plate 40 can be supported at the support leg portions 9. This configuration might help position the spring plate 40 when the spring plate 40 is arranged in a push switch.

In this embodiment, the first support leg portion 9 (9A) is positioned between the first leg portion 2 (2A) and the second leg portion 2 (2B). The second support leg portion 9 (9B) is positioned between the third leg portion 2 (2C) and the fourth leg portion 2 (2D).

As shown in FIG. 4B, the spring plate 50 further includes more support leg portions. The spring plate 50 includes four support leg portions 9. The third support leg portion 9 (9C) is positioned between the first leg portion 2 (2A) and the fourth leg portion 2 (2D). The fourth support leg portion 9 (9D) is positioned between the second leg portion 2 (2B) and the third leg portion 2 (2C).

FIG. 4C shows a cross-sectional view of a spring plate, taken along a dot-and-dash line IVC-IVC shown in FIG. 4A or FIG. 4B. FIG. 4D also shows a cross-sectional view of a spring plate, taken along a dot-and-dash line IVD-IVD shown in FIG. 4A or FIG. 4B. The central portion 1 may include a central opening 7 with an extension, which may be in contact with a first electrode 14 below the central portion 1 of the spring plate 50. This extension may improve a click feeling of a user when a push switch including the spring plate 50 is pressed down by the user. The spring plate 50 may include openings 8 (Sa, 8b, 8c, 8d) through the central portion 1 of the spring plate 50 around the central opening 7.

FIG. 5A shows a top perspective view of a spring plate according to a sixth embodiment of the subject matter. In this embodiment, a switch 60 includes a central portion 1 that has a circular shape. Regarding the leg portion 2, descriptions about FIG. 1A-1C may be referred to.

FIG. 5B shows a cross-sectional view of a spring plate, taken along a dot-and-dash line VB-VB shown in FIG. 5A.

FIG. 6A shows a top perspective view of a spring plate according to a seventh embodiment of the subject matter.

FIG. 6B shows a top perspective view of a spring plate according to an eighth embodiment of the subject matter.

Regarding the leg portion 2 and the support leg portion 9, descriptions about FIG. 4A-4D may be referred to.

FIG. 6C shows a cross-sectional view of a spring plate, taken along a dot-and-dash line VIC-VIC shown in FIG. 6A or FIG. 6B.

FIG. 6D shows a cross-sectional view of a spring plate, taken along a dot-and-dash line VID-VID shown in FIG. 6A or FIG. 6B. FIG. 6C shows a cross-sectional view crossing across a support leg portion.

FIG. 7A shows a top perspective view of a push switch 100 according to a ninth embodiment of the subject matter.

FIG. 7B shows a bottom perspective view of a push switch 100 shown in FIG. 7A.

FIG. 7C shows an explosive perspective view of a push switch shown in FIG. 7A. The push switch may further include a sheet 210 covering the spring plate. A push switch 100 includes a spring plate 30. The spring plate 30 includes a central portion 1, a leg portion 2 projecting outward from an edge 1c of the central portion 1. The leg portion 2 includes a hollow portion 3 that is positioned within an outline 2c of the leg portion 2 in a top plan view. The push switch 100 further includes a first electrode 14 arranged below the central portion 1 of the spring plate 30, and a second electrode 15 on which the hollow portion 3 of the leg portion 2 of the spring plate 10 is arranged. The number of leg portions 2 may be two or more.

In this embodiment, the push switch 100 includes a substrate 11 including the first electrode 14 and the second electrode 15, which is positioned outside a position of the first electrode 14. The term “substrate” herein may include a resin body has a plate shape, a resin body including a sunken portion in the resin body, and/or a resin body including metal leads. Also, the term “substrate” herein may include a flexible printed circuit board. Also, the term “substrate” herein may be a motherboard, which belongs to an electronic device. A substrate may belong to a push switch and/or to an electronic device.

For more details, a push switch 100 includes a spring plate 30. The spring plate 30 includes a central portion 1, and a leg portion 2 projecting outward from an edge 1c of the central portion 1. The leg portion 2 includes a hollow portion 3 that is positioned within an outline 2c of the leg portion 2 in a top plan view. The substrate 11 may include a first surface 11a, a second surface 11b that is positioned opposite to the first surface 11a, a peripheral side surface 11c between the first surface 11a and the second surface 11b. The first electrode 14 is arranged on the first surface 11a of the substrate 11, and a second electrode 15 is arranged on the first surface 11a of the substrate 11. The hollow portion 3 of the leg portion 2 of the spring plate 30 includes a bottom 4 that includes a first surface 4a and a second surface 4b opposite to the first surface 4a of the bottom 4. The hollow portion 3 further includes a surrounding surface 5 that surrounds the first surface 4a of the bottom 4 of the hollow portion 3. The second surface 4b of the bottom 4 of the hollow portion 3 is arranged on the second electrode 15 arranged on the first surface 11a of the substrate 11. The second surface 4b of the bottom 4 of the hollow portion 3 may be a flat surface.

In this embodiment, the push switch 100 further includes a frame 12 that is arranged on the first surface 11a of the substrate 11. The frame 12 includes an opening 160 passing through the frame 12 from an upper surface 12a to a lower surface 12b. The first electrode 14 may be positioned in the opening 160. The second electrode 15 may be positioned in the opening 160 and/or adjacent to an outline of the opening 160. The opening 160 of the frame 12 has a shape to house the spring plate 30. The central portion 1 of the spring plate 30 is arranged over the first electrode 14 and the leg portion 2 is arranged on the second electrode 15. Two or more second electrodes 15 may be arranged around the first electrode 14, and two or more leg portions 2 may be arranged in contact with the two or more second electrodes 15.

FIG. 8A shows a top perspective view of a push switch 200 according to a tenth embodiment of the subject matter. FIG. 8B shows a bottom perspective view of a push switch 200 shown in FIG. 8A. FIG. 8C shows an explosive perspective view of a push switch shown in FIG. 8A. The push switch further includes a sheet 210 covering the spring plate.

In this embodiment, a push switch 200 includes a substrate 11 comprising at least two metal leads 16 that are partly embedded in the substrate 11. In this embodiment, the substrate 11 may be a resin body including metal leads 16 (16a, 16b, 16c, and 16d). The substrate 11 may include a sunken portion 17 in which the spring plate 30 is arranged.

The metal leads 16 may be used to electrically connect the push switch 200 on a substrate, which may belong to an electronic device. Also, the metal leads 16 may be used to fix the push switch 200 on the substrate of the electronic device.

In this embodiment, the substrate 11 includes a first electrode 14 arranged at a center in the sunken portion 17 of the substrate 11. The substrate 11 further includes a second electrode 14 that is positioned adjacent to a periphery in the sunken portion 17 of the substrate 11. The second electrode 14 may be arranged to surround the first electrode 14. The at least two metal leads 16 may include a first metal lead 16a, a second metal lead 16b, a third metal lead 16c, and a fourth metal lead 16d. The first electrode 14 may be electrically connected to a first metal lead 16a, for example. The second electrode 15 may be electrically connected to a second metal lead 16b, for example. The metal leads 16 may be used for the push switch 100 being electrically and/or physically connected to electrodes arranged on a flexible printed circuit board of an electronic device, for example.

The push switch 200 may include a sheet 210 that covers the spring plate 210. The sheet 210 may be arranged on the substrate 11 to cover the spring plate 30. The sheet 210 may be arranged to prevent a foreign substance from entering inside the push switch 200. The push switch may further include a pressing member 62 on which a pressing force may be directly applied from above the push switch shown in FIGS. 15A and 15B, for example.

FIG. 9A shows a top perspective view of a push switch 300 according to an eleventh embodiment of the subject matter. In this embodiment the push switch 300 is electrically mounted on a surface 1001a of a motherboard 1001, which may belong to an electronic device 1000.

FIG. 9B shows an explosive perspective view of a push switch 50 shown in FIG. 9A. FIG. 9C (a) shows a spring plate 50, FIG. 9C (b) shows a frame 12, and FIG. 9C (c) shows the frame 12, in which the spring plate 50 is set. In this embodiment, the frame 12 includes an opening 160 passing through the frame 12 from an upper surface 12a to a lower surface 12b. The frame 12 in this embodiment further includes 12 a support 18 that may support the first support leg portion 9 of the spring plate 50 arranged in the opening 160. The support 18 may be positioned adjacent to a periphery of the opening 160.

The frame 12 in which the spring plate 50 is set may be a switch part. The switch part may be directly mounted on a substrate, which belongs to an electronic device.

An electronic device 1000 may include a motherboard 1001. The motherboard 1001 may include a first surface 1001a, a first electrode 1002 arranged on the first surface 1001a, and a second electrode 1003 arranged outside a position of the first electrode 1002.

A switch 300 may include a spring plate 40 including a central portion 1, a first leg portion 2 (2A) projecting outward from an edge 1c of the central portion 1, a second leg portion 2 (2B) projecting outward from the edge 1c of the central portion 1, a third leg portion 2 (2C) projecting outward from the edge 1c of the central portion 1, and a fourth leg portion 9 (9D) projecting outward from the edge 1c of the central portion 1. The spring plate 40 may further includes a first support leg portion 9 projecting outward from the edge 1c of the central portion 1 and being positioned between at least two of the first leg portion 2 (2A), the second leg portion 2 (2B), the third leg portion 2 (2C) and the fourth leg portion 2 (2D).

The push switch 300 further includes a frame 12 that includes an opening 160 passing through the frame 12 from an upper surface 12 a to a lower surface 12b. The frame 12 further includes a support 18 that supports the first support leg portion 9 (9A) arranged in the opening 160. The frame 12 in this embodiment includes a first support 18 (18a) that supports the first support leg portion 9 (9A), a second support 18 (18b) that supports the second support leg portion 9 (9B), a third support 18 (18c) that supports the third support leg portion 9 (9C), and a fourth support 18 (18d) that supports the fourth support leg portion 9 (9D).

FIG. 10A shows a top plan view of a push switch 400 according to a twelfth embodiment of the subject matter.

FIG. 10B shows an explosive perspective view of a push switch shown in FIG. 10A. FIG. 10C shows a film 19 including a first layer 23 with an upper electrode 14, a second layer 22 with a hole, and a third layer 21 with a lower electrode 15.

The push switch 400 includes a spring plate 50 that is shown in FIG. 4B and a film 19 shown in FIG. 10C. The film 19 including a first layer 21 that includes an upper surface 21a and a lower surface 21b opposite to the upper surface 21a, a second layer 22 that includes an upper surface 22a and a lower surface 22b opposite to the upper surface 22a, and a third layer 23 that includes an upper surface 23a and a lower surface 23b opposite to the upper surface 23a.

The first layer 21 of the film 19 includes a first electrode 14 arranged on the upper surface 21a of the first layer 21. The second layer 22 of the film 19 includes a hole 24 passing through the second layer 22 from the upper surface 22a to the lower surface 22b of the second layer 22. The third layer 23 of the film 19 includes a second electrode 15 arranged on the lower surface 23b of the third layer 23. The second electrode 15 arranged on the lower surface 23b of the third layer 23 of the film 19, the hole 24 of the second layer 22 of the film 19, and the first electrode 14 arranged on the upper surface 21a of the first layer 21 are positioned below the central portion 1 of the spring plate 40.

In this embodiment, the hollow portions 3 of the leg portions 2 of the spring plate 50 are arranged in contact with the film 19. The second surface 4b of the bottom 4 of the hollow portion 3 is arranged on the film 19. The second surface 4b of the bottom 4 of the hollow portion 3 may be a flat surface. The shape of the hollow portion 3 at the leg portion 2 of the spring plate 1 according to this embodiment of the subject matter may give less impair a surface quality of the film 19, compared to a shape including and/or connected to a part of a cross section of a spring plate, for example. The spring plate may be cut out from a metal plate. If the part of cross section of the spring plate is rubbed on the film 19, bits of the film 19 may occur. However, in this embodiment, since the hollow portion at the leg portion of the spring plate is positioned within the outline of the spring plate, the lower surface 4b of the bottom 4 of the hollow portion on the second electrode is free from a cross section of the spring plate.

FIG. 11A shows a top perspective view of a push switch 500 according to a thirteenth embodiment of the subject matter. FIG. 11B shows a bottom perspective view of a push switch 500 shown in FIG. 11A.

FIG. 11C shows an explosive perspective view of a push switch shown in FIG. 11A. The push switch further includes a sheet 210 covering the spring plate. In this embodiment, the spring plate 60 has a central portion 1 that has a circular shape in a top plan view. The substrate 11 may include a first electrode 14 and a second electrode 15 that are arranged on an upper surface 11a of the substrate 11. The substrate 11 may include a through-hole in the substrate 11. The substrate 11 may include a ¼ through hole at a corner of the substrate 11. The through-hole and/or the ¼ through-hole may be electrically connected to the first electrode 14 and/or the second electrode 15.

FIG. 12A shows a top perspective view of a push switch 600 according to a fourteenth embodiment of the subject matter. FIG. 12B shows a bottom perspective view of a push switch shown in FIG. 12A. FIG. 12C shows an explosive perspective view of a push switch 600. The substrate 11 in this embodiment is a resin body including a sunken portion 17 in the resin body. The resin body may include metal leads 16 (16a, 16b, 16c, 16d).

FIG. 13A shows a top perspective view of a push switch 700 according to a fifteenth embodiment of the subject matter.

FIG. 13B shows a push switch with a sheet 210, which covers a spring plate shown in FIG. 13A, removed from the push switch.

FIG. 13C shows an explosive perspective view of a push switch 700 shown in FIG. 13A.

FIG. 13D (a) shows a spring plate 60. FIG. 13D (b) shows a frame 12 with an opening. FIG. 13 (c) shows the frame with the opening, in which the spring plate 60 is set.

FIG. 14A shows a top perspective view of a push switch 800 according to a sixteenth embodiment of the subject matter.

FIG. 14B shows an explosive perspective view of a push switch 800 shown in FIG. 14A. The push switch 800 includes a spring plate 80, and a film 19. The film 19 includes a first layer 21 that includes an upper surface 21a and a lower surface 21b opposite to the upper surface 21a, a second layer 22 that includes an upper surface 22a and a lower surface 22b opposite to the upper surface 22a, and a third layer 23 that includes an upper surface 23a and a lower surface 23b opposite to the upper surface 23a. The first layer 21 of the film 19 includes a first electrode 14 arranged on the upper surface 21b of the first layer 21. The second layer 22 of the film 19 includes a hole 24 passing through the second layer 22 from the upper surface 22a to the lower surface 22b of the second layer 22. The third layer 23 of the film 19 includes a second electrode 15 arranged on the lower surface 23b of the third layer 23.

The second electrode 15 arranged on the lower surface 23b of the third layer 23 of the film 19, the hole 24 of the second layer 22 of the film 19, and the first electrode 14 arranged on the upper surface 21a of the first layer 21 are positioned below the central portion 1 of the spring plate 40. The film 19 is shown in FIG. 10C.

FIG. 15A shows an electronic device including a switch according to an embodiment of the subject matter.

FIG. 15B shows a switch according to an embodiment of the subject matter. The switch may be mounted on a motherboard that is a flexible printed circuit board.

An electronic device 3000 includes a motherboard 3001 and a push switch 100, 200, 300, 400, 500, 600, 700, or 800 according to the subject matter disclosed herein. The motherboard 3001 includes electrodes that may include a first electrode and a second electrode to which the push switch 100, 200, 300, 400, 500, 600, 700, or 800 is electrically connected. The motherboard 3001 may be a flexible printed circuit board. The push switch according to the subject matter may be arranged at a side 3000c of the electronic device 3000. The push switch according to the subject matter herein may be arranged horizontally and/or vertically in and/or on an electronic device.

Various electronic devices include push switches. An electronic device includes the push switch according to an embodiment of the subject matter, and a motherboard includes a first electrode and a second electrode. The push switch may be electrically connected to the first electrode and the second electrode of the motherboard of the electronic device.

Furthermore, while certain embodiments of the present inventive subject matter have been illustrated with reference to specific combinations of elements, various other combinations may also be provided without departing from the teachings of the present inventive subject matter. Thus, the present inventive subject matter should not be construed as being limited to the particular exemplary embodiments described herein and illustrated in the Figures, but may also encompass combinations of elements of the various illustrated embodiments.

Many alterations and modifications may be made by those having ordinary skill in the art, given the benefit of the present disclosure, without departing from the spirit and scope of the inventive subject matter. Therefore, it must be understood that the illustrated embodiments have been set forth only for the purposes of example, and that it should not be taken as limiting the inventive subject matter as defined by the following claims. The following claims are, therefore, to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the inventive subject matter.

What is claimed is:

1. A spring plate comprising:
a central portion;
a first leg portion projecting outward from an edge of the central portion; and
a second leg portion projecting outward from the edge of the central portion,
the first leg portion comprising a hollow portion that is positioned within an outline of the first leg portion in a top plan view, and
the second leg portion comprising a hollow portion that is positioned within an outline of the second leg portion in a top plan view.

2. The spring plate according to claim 1, wherein
the hollow portion of the first leg portion comprises a bottom and a surrounding surface that surrounds the bottom, and
the hollow portion of the second leg portion comprises a bottom and a surrounding surface that surrounds the bottom.

3. The spring plate according to claim 2, wherein
the hollow portion of the first leg portion comprises a cup shape, and
the hollow portion of the second leg portion comprises a cup shape.

4. The spring plate according to claim 1,
wherein the central portion comprising a convex shape.

5. The spring plate according to claim 1, wherein the first leg portion is positioned opposite to the second leg portion.

6. The spring plate according to claim 1, wherein the first leg portion is positioned with a space from the second leg portion.

7. The spring plate according to claim 1 further comprising:
a first support leg portion projecting outward from the edge of the central portion and being positioned between the first leg portion and the second leg portion; and
a second support leg portion projecting outward from the edge of the central portion and being positioned opposite to the first support leg portion between the third leg portion and the fourth leg portion.

8. The spring plate according to claim 1,
wherein the first leg portion includes a slant portion that is positioned closer to the central portion than the hollow portion of the first leg portion, and
wherein the second leg portion includes a slant portion that is positioned closer to the central portion than the hollow portion of the second leg portion.

9. A spring plate comprising:
a central portion;
a first leg portion projecting outward from an edge of the central portion;
a second leg portion projecting outward from the edge of the central portion;
a third leg portion projecting outward from the edge of the central portion; and
a fourth leg portion projecting outward from the edge of the central portion,
the first leg portion, the second leg portion, the third leg portion and the fourth leg portion being positioned around the central portion at regular intervals,
the first leg portion comprising a hollow portion that is positioned within an outline of the first leg portion in a top plan view,
the second leg portion comprising a hollow portion that is positioned within an outline of the second leg portion in a top plan view,
the third leg portion comprising a hollow portion that is positioned within an outline of the third leg portion in a top plan view and
the fourth leg portion comprising a hollow portion that is positioned within an outline of the fourth leg portion in a top plan view.

10. The spring plate according to claim 9 further comprising:
a first support leg portion projecting outward from the edge of the central portion.

11. The spring plate according to claim 10 further comprising:
a second support leg portion projecting outward from the edge of the central portion, the second support leg portion being positioned opposite to the second support leg portion.

12. The spring plate according to claim 11 further comprising:
a third support leg portion projecting outward from the edge of the central portion.

13. A push switch comprising:
a spring plate comprising a central portion, a leg portion projecting outward from an edge of the central portion, the leg portion comprising a hollow portion that is positioned within an outline of the leg portion in a top plan view;
a first electrode arranged below the central portion of the spring plate; and
a second electrode on that the hollow portion of the leg portion of the spring plate is arranged.

14. The push switch according to claim 13,
wherein the hollow portion of the leg portion of the plate spring comprises a bottom and a surrounding surface that surrounds the bottom.

15. The push switch according to claim 13,
wherein the hollow portion of the leg portion comprises a cup shape.

16. The push switch according to claim 13,
wherein the leg portion includes a slant portion that is positioned closer to the edge of the central portion than the hollow portion.

17. The push switch according to claim 13 further comprising:
a substrate comprising the first electrode and the second electrode, that is positioned outside a position of the first electrode.

18. A push switch comprising:
a spring plate comprising a central portion, a leg portion projecting outward from an edge of the central portion, the leg portion comprising a hollow portion that is positioned within an outline of the leg portion in a top plan view;
a substrate comprising a first surface, a second surface that is positioned opposite to the first surface, a peripheral side surface between the first surface and the second surface; and
a first electrode arranged on the first surface of the substrate and a second electrode arranged on the first surface of the substrate,
the hollow portion of the leg portion of the spring plate comprising a bottom that comprises a first surface and a second surface opposite to the first surface of the bottom, the hollow portion further comprising a surrounding surface that surrounds the first surface of the bottom of the hollow portion, and the second surface of the bottom of the hollow portion being arranged on the second electrode arranged on the first surface of the substrate.

19. A push switch according to claim 18 further comprising:
a substrate comprising at least two metal leads that are partly embedded in the substrate and a sunken portion in that the plate spring is arranged.

20. A push switch comprising:
a spring plate according to claim 1; and
a film comprising a first layer that comprises an upper surface and a lower surface opposite to the upper surface, a second layer that comprises an upper surface and a lower surface opposite to the upper surface, and a third layer that comprises an upper surface and a lower surface opposite to the upper surface,
the first layer of the film comprising a first electrode arranged on the upper surface of the first layer,
the second layer of the film comprising a hole passing through the second layer from the upper surface to the lower surface of the second layer,
the third layer of the film comprising a second electrode arranged on the lower surface of the third layer,
wherein the second electrode arranged on the lower surface of the third layer of the film, the hole of the second layer of the film, and the first electrode arranged on the upper surface of the first layer are positioned below the central portion of the spring plate.

21. An electronic device comprising:
the push switch of claim 13; and
a substrate comprising the first electrode arranged below the central portion of the spring plate and the second electrode on that the hollow portion of the leg portion of the spring plate is arranged.
